(19) United States
(12) Patent Application Publication
(10) Pub. No.: US 2025/0141551 A1
(43) Pub. Date: May 1, 2025

(54) BI-DIRECTIONAL OPTICAL COMPONENTS FOR MULTI-CORE AMPLIFIED TRANSMISSION

(71) Applicant: SUBCOM, LLC, Eatontown, NJ (US)

(72) Inventors: Georg Heinrich Mohs, East Brunswick, NJ (US); Alexei Pilipetskii, Long Branch, NJ (US)

(73) Assignee: SUBCOM, LLC, Eatontown, NJ (US)

(21) Appl. No.: 18/925,475

(22) Filed: Oct. 24, 2024

Related U.S. Application Data
(60) Provisional application No. 63/593,054, filed on Oct. 25, 2023.

(51) Int. Cl. H04B 10/25; H04B 10/2581

(52) U.S. Cl. CPC H04B 10/25891; H04B 10/2581

(57) ABSTRACT

A method and a system for transmission of optical signals. One or more first and second multi-core optical components are coupled to all fiber cores in a multi-core fiber. An erbium-doped fiber amplifier (EDFA) optical component is coupled to all fiber cores in the multi-core fiber and includes a plurality of EDFAs. Each fiber core is coupled to an EDFA. The EDFA optical component is coupled to all fiber cores between the first and second multi-core optical components. First multi-core components are coupled at an input to a first portion of fiber cores and provide first functions, and are coupled at an output from a second portion of fiber cores and provide second functions. Second multi-core components are coupled at an output from the first portion of fiber cores and provide second functions, and are coupled to an input to the second portion of fiber cores and provide first functions.

### CROSS-REFERENCE TO RELATED APPLICATIONS

The present application claims the benefit of priority to U.S. Provisional Patent Appl. No. 63/593,054 to Mohs et al., filed Oct. 25, 2023, and entitled “Bi-Directional Optical Components for Multi-Core Amplified Transmission,” and incorporates its disclosure herein by reference in its entirety.

### TECHNICAL FIELD

This disclosure relates generally to optical communication systems, and in particular to bi-directional optical components for multi-core amplified transmissions.

### BACKGROUND

Submarine optical cables are laid on the seabed or ocean floor between land-based terminals to carry optical signals across long stretches of ocean and sea. The optical cables typically include several optical fiber pairs and other components such as strengthening members, a power conductor, an electrical insulator and a protective shield. The optical fibers may be single core/mode fibers or multi-mode/core fibers. The first fiber of a fiber pair may be coupled in the system for communicating signals in a first direction on the cable and the second fiber of the fiber pair may be configured for communicating signals in a second direction, opposite the first direction, on the cable to support bi-directional communications.

### SUMMARY

In some implementations, the current subject matter relates to an apparatus for transmission of optical signals. The apparatus may include one or more first multi-core optical components coupled to all fiber cores in a multi-core fiber; an erbium-doped fiber amplifier (EDFA) optical component coupled to all fiber cores in the multi-core fiber, wherein the EDFA optical component includes a plurality of EDFAs and each fiber core in the multi-core fiber is coupled to an EDFA in the plurality of EDFAs; one or more second multi-core optical components coupled to all fiber cores in the multi-core fiber, wherein the EDFA optical component is coupled to all fiber cores in the multi-core fiber between the one or more first multi-core optical components and the one or more second multi-core optical components. The first multi-core components are coupled at an input to a first portion of fiber cores in all fiber cores and provide one or more first functions, and are coupled at an output from a second portion of fiber cores in all fiber cores and provide one or more second functions. The second multi-core components are coupled at an output from the first portion of fiber cores in all fiber cores and provide one or more second functions, and are coupled to an input to the second portion of fiber cores in all fiber cores and provide the one or more first functions.

In some implementations, the current subject matter may include one or more of the following optional features. The first portion of fiber cores transmits optical signals in an opposite direction to a direction of transmission of optical signals by the second portion of fiber cores. The first functions are provided by at least one of: a first isolator, a wavelength division multiplexing (WDM) optical component, and any combination thereof. The WDM optical component is coupled to a pump.

In some implementations, the second functions are provided by at least one of: a tap optical component, a gain flattening filter (GFF), a second isolator, and any combination thereof. The tap optical components of adjacent fiber cores in all fiber cores are communicatively coupled. The tap optical component, the gain flattening filter (GFF), and the second isolator are disposed within a single multi-core component in at least one of: the one or more first multi-core components and the one or more second multi-core components. Alternatively, or in addition, the tap optical component and the second isolator are disposed within a single multi-core component in at least one of: the one or more first multi-core components and the one or more second multi-core components; and the gain flattening filter (GFF) is disposed within another single multi-core component in at least one of: the one or more first multi-core components and the one or more second multi-core components. The tap optical components are configured to provide monitoring of one or more fiber cores in all cores.

In some implementations, the multi-core fiber includes at least one of: two fiber cores, four fiber cores, and any combination thereof.

In some implementations, the current subject matter relates to a method for transmission of optical signals. The method may include providing an apparatus for transmission of optical signals that may include one or more of the features described herein, and transmitting, using the apparatus, one or more optical signals on or more fiber cores.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary optical communication system;

FIG. 2 illustrates an example of a 4-core fiber with propagation of data in cores 1 and 3 in one direction (e.g., right to left), and in cores 2 and 4 in opposite (e.g., left to right) to minimize core crosstalk;

FIG. 3 illustrates amplification of each core in separate single core (e.g., single mode) EDFAs using FIFO devices to separate cores;

FIG. 4 illustrates an optical signal communication system that includes fiber amplifier pair with two EDFs, loopback and set of discreet components;

FIG. 5 illustrates an example optical communication system that may include a 4-core bi-directional amplifier with 4-core EDF, and 4-core multifunctional components, according to some implementations of the current subject matter;

FIG. 6 illustrates further details of a 4-core multifunctional component shown in FIG. 5, according to some implementations of the current subject matter;

FIGS. 7-8 illustrate another example 4-core bi-directional amplifier optical signal communications systems that may include 4-core EDF and 4-core multifunctional components, according to some implementations of the current subject matter; and

FIG. 9 illustrates an exemplary system, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide bi-directional optical components for multi-core amplified transmissions.

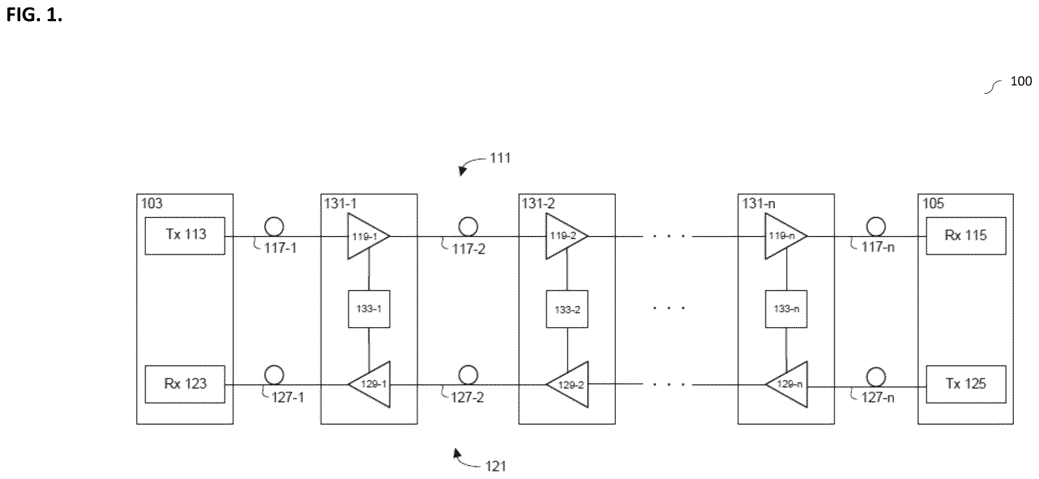

FIG. 1 illustrates an exemplary optical communication system 100. The system 100 may use high-bandwidth fiber optics to transmit/receive vast amounts of data over long distances. The bidirectional optical communication system 100 may also be referred to as a long-haul optical communication system. Bidirectional data transmission may be implemented by constructing pairs of optical fibers within an optical cable and/or transmitting one or more channels, e.g., wavelength division multiplexed channels, per fiber pair.

The system 100 may include terminals 103 and 105 communicatively coupled using (e.g., unidirectional) optical paths 111, 121. The terminal 103 may include a transmitter 113 and a receiver 123. Likewise, the terminal 105 may include a receiver 115 and a transmitter 125. The transmitter 113 of the terminal 103 may be communicatively coupled to the receiver 115 of the terminal 105 via the path 111. The transmitter 125 of the terminal 105 may be communicatively coupled to the receiver 123 of the terminal 103 via the communication path 121. The paths 111, 121 may form a bidirectional optical fiber pair. For example, the optical path 111 may transmit signal(s), data, information, etc. and/or any combination thereof in one direction, e.g., from the transmitter 113 to the receiver 115. Optical path 121 may transmit signal(s), data, information, etc. and/or any combination thereof in another direction, e.g., from the transmitter 125 to the receiver 123.

Thus, with respect to the terminal 103, the optical path 111 may be referred to as an outbound path and the optical path 121 may be referred to as an inbound path. The optical path 111 may include one or more optical fibers 117-1 to 117-n and one or more optical amplifiers 119-1 to 119-n, the latter being positioned within respective repeaters 131-1 to 131-n. Similarly, the optical path 121 may include one or more optical fibers 127-1 to 127-n and one or more optical amplifiers 129-1 to 129-n, the latter being positioned within the respective repeaters 131-1 to 131-n. The optical fibers 117-1 to 117-n and 127-1 to 127-2 may be individual segments of a single optical fiber 117 and/or a single optical fiber 127, respectively, where the segments may be formed by way of coupling of the amplifiers to the optical fibers 117 and 127, as shown in FIG. 1.

For example, one or more optical amplifiers 119-1 to 119-n and/or 129-1 to 129-n may be Erbium-doped fiber amplifiers (EDFAs), and/or any other optical amplifiers. Further, while transmitters 113, 115 and receivers 123, 125 are shown as separate components, as can be understood, transmitter 113 and/or receiver 123 may be housed together in a single housing and may form a transponder and/or transceiver at the terminal 103. Similarly, transmitter 115 and receiver 125 may also be housed together in a single housing and may form a transponder and/or transceiver at terminal 105.

As stated above, the optical path pair (e.g., optical paths 111, 121) may be configured as a set of amplifier pairs 119-1 to 119-n and 129-1 to 129-n within repeaters 131-1 to 131-n communicatively coupled thereto using pairs of optical fibers 117 (e.g., using optical fibers 117-1 to 117-n) and 127 (e.g., using optical fibers 127-1 to 127-n), which may be included in an optical fiber cable together with other fibers and/or fiber pairs supporting additional path pairs. As discussed above and shown in FIG. 1, for example, each repeater 131-1 to 131-n may include at least a pair of respective amplifiers 119-1 to 119-n, 129-1 to 129-n for each path pair and/or may include additional amplifiers for additional path pairs. As shown in FIG. 1, for example, the repeater 131-1 may include amplifiers 119-1 and 129-1.

The optical amplifiers 119-1 to 119-n, 129-1 to 129-n may include EDFAs and/or other rare earth doped fiber amplifiers, e.g., Raman amplifiers, semiconductor optical amplifiers (SOAs). Each repeater 131-1 to 131-n may also include respective coupling paths 133-1 to 133-n that may be communicatively coupled between optical paths 111, 121. It may be understood that the term “couple” and/or “coupled” and/or “communicatively coupled”, as used herein, may broadly refer to any connection, connecting, coupling, link, and/or linking, direct and/or indirect and/or wired and/or wireless connection, etc. but does not necessarily imply that the coupled components and/or elements are directly connected to each other.

Existing cables utilize single mode fiber as transmission fiber. To save space in a cable and increase overall aggregate cable capacity multi-core fiber was suggested instead. Multicore fiber (MCF) has a few fiber cores in a single cladding that guide and contain light signals instead of one core in regular single more fibers. The simplest approach to signal amplification with MCF is the use of fan-in fan-out (FIFO) devices splitting MCF multicore input into separate optical paths and using the same components including EDFA as for single mode operation. Despite being simple, this approach has drawbacks, adding extra optical components (FIFOs) with additional loss, and not leading to space savings in the repeater housing. Use of MCF increases maximum number of cores in a cable, but it may also create a need to save space in repeater housing due to the need to amplify multiple cores.

In some cases, a 4-core transmission fiber with signals co-propagating in all cores may be used, which may include 4-core components, e.g., 4-core wavelength-division multiplexers (WDMs), 4-core isolators, 4-core gain flattening filters (GFFs), with signals propagating in one direction. The 4-core MCF with co-propagating signals may be coupled core fiber, which may mean that optical data signals in all cores may be coupled together and special transponder DSP may be applied and developed to process data channels.

In some implementations, the current subject matter provides a multi-core solution that mitigates the need for FIFO devices and allows for use of 4-core EDF. The current subject matter may be compatible with 4-core MCF with uncoupled core transmission that may be compatible with regular modem DSP used in SMF transmission. As can be understood, the current subject matter may be compatible with any type of optical communication cables, paths, links, etc.

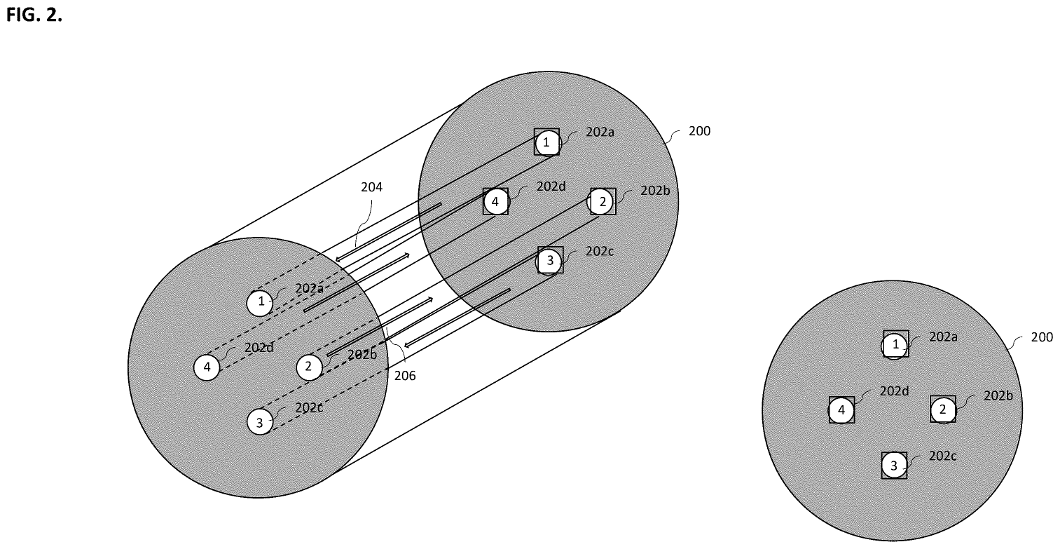

In some example, non-limiting, implementations, the current subject matter may be configured to provide an optical signal transmission system that may use 4-core or multi-core MCF with data counterpropagating in cores closest to each other (as shown in FIG. 2). It may also use 4-core or multi-core component ecosystem that does not require use of FIFO devices. Further, the system may implement 4-core or multi-core EDF as apart of 4-core component ecosystem. Moreover, 4-core or multi-core multifunctional component that may include isolator(s) and WDM(s) on two diagonal cores and isolator(s), GFF(s) and tap(s) on two other diagonal cores may be implemented. Alternatively, or in addition, two types of 4-core or multi-core components may be implemented: a) GFFs on two of 4 diagonal cores, and b) isolator(s) and WDM(s) on two diagonal cores and isolator plus tap on two others.

FIG. 2 illustrates an example of a fiber 200, and in particular, showing a perspective view of the fiber 200 (upper part of FIG. 2) and a cross-sectional view of the fiber 200 (bottom part of FIG. 2). Fiber 200 may be a multi-core fiber, e.g., a 4-core fiber, and may include one or more fiber cores 202 (a, b, c, d).

As shown in FIG. 2, the optical signals, data, etc. may be configured to propagate within the fiber cores 202 in different directions. For example, the optical signals, data, etc. in fiber cores 1 202a and 3 202c may propagate in a direction 204 (e.g., right to left), and the optical signals, data, etc. may propagate in cores 2 202b and 4 202d in an opposite direction 206 (e.g., left to right). This may allow fiber 200 to minimize core crosstalk.

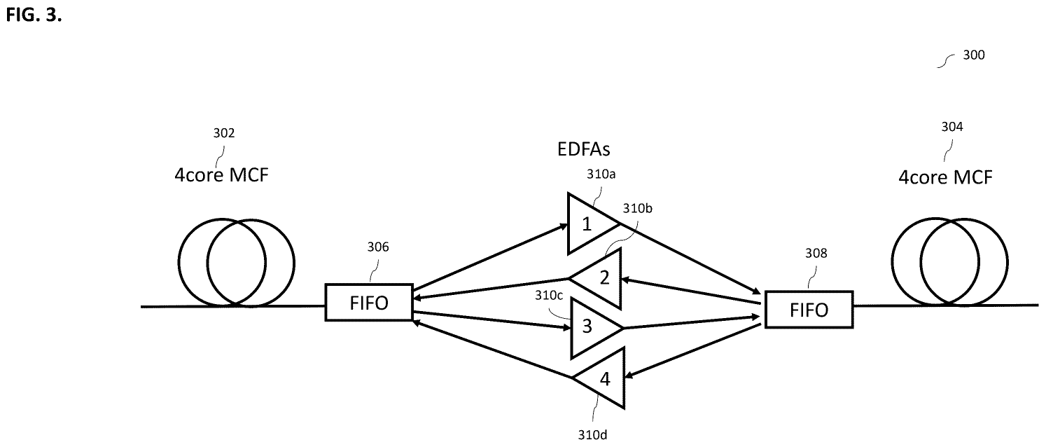

FIG. 3 illustrates an example of an amplification system 300 that may implement one or more multi-core fibers 200 shown in FIG. 2. The system 300 may be configured to perform amplification of one or more or of each core in separate single core (e.g., single mode) EDFA using one or more FIFO devices coupled to separate cores. In particular, one or more EDFAs may perform amplification of one or more optical signals in one or more or all cores by separating and recombining cores using FIFO devices.

As shown in FIG. 3, the system 300 may include a FIFO device 306, a FIFO device 308, and one or more EDFAs 310 (a, b, c, d). The FIFO device 306 may be communicatively coupled to the multi-core fiber 302 (e.g., a 4-core fiber similar to the fiber 300 shown in FIG. 3). The FIFO device 308 may be communicatively coupled to the multi-core fiber 304 (e.g., a 4-core fiber similar to the fiber 300). The FIFO devices 306 and 308 may be communicatively coupled to the EDFAs 310.

The EDFAs 310 may be configured to amplify optical signals transmitted on the fibers 302 and 304 either to and/or from the FIFO devices 306, 308. For example, an optical signal transmitted on the fiber 302 toward fiber 304, may be transmitted from the FIFO device 306 to the EDFAs 1 310a and/or 3 310c. The EDFAs 310a and 310c may amplify the optical signal received from the FIFO device 306 and transmit the amplified optical signal to the FIFO device 308 for further transmission on the fiber 304.

Similarly, an optical signal transmitted on the fiber 304 toward fiber 302, may be transmitted from the FIFO device 308 to the EDFAs 2 310b and/or 4 310d. The EDFAs 310b and 310d may amplify the optical signal received from the FIFO device 308 and transmit the amplified optical signal to the FIFO device 306 for further transmission on the fiber 302.

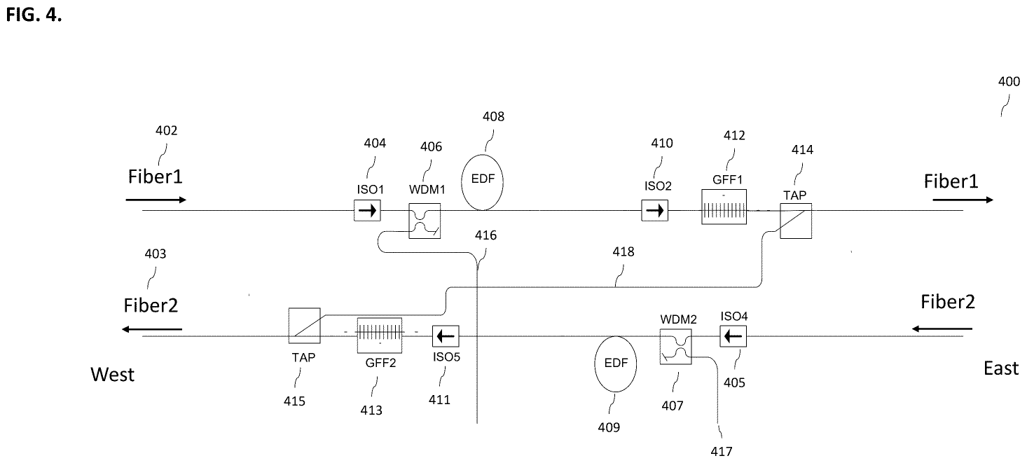

FIG. 4 illustrates an optical signal communication system 400 for transmission of optical communication signals. As shown in FIG. 4, the system 400 may include that may include a pair of fibers—fiber 1 402 and fiber 2 403. The fibers 402, 403 may be communicatively coupled to one or more terminals (e.g., receiver and/or transmitter and/or both) and/or any other optical communications components (not shown in FIG. 4) Each fiber 402, 403 may include one or more discrete respective components positioned thereon along with a loopback component. Each of the fibers 402, 403 may be configured to transmit optical signals in a predetermined direction. For example, fiber 402 may be configured to transmit optical signals from west to cast and fiber 403 may be configured to transmit optical signals from east to west. As can be understood, the indicated directions are provided herein for exemplary purposes and are not intended to limit the current subject matter.

The fiber 1 402 may include an isolator (ISO1) 404, a wave division multiplexing (WDM1) optical component 406, a section of erbium doped fiber (EDF) 408, an isolator (ISO2) 410, a gain flattening filter (GFF1) 412, and a tap optical component 414 that may be positioned thereon. In particular, the isolator 404 may be configured to be communicatively coupled to the WDM1 optical component 406, which, in turn, may be communicatively coupled to the isolator 410 via EDF 408, which may amplify the optical signal. It may be understood that an optical isolator may be a passive magneto-optic device that only allows light to travel in one direction and may be used to protect a source from back reflections or signals that may occur downstream of the isolator. The terms “downstream” and “upstream” herein may be understood to broadly refer to a position of a component relative to a position of a different component in view of the direction of optical signal flow. The isolator 410 may be communicatively coupled to the GFF1 412, which, in turn, may be communicatively coupled to the tap optical component 414 for further communicative coupling to other optical components. A gain flattening filter or a gain equalizing filter may be used to smooth out and/or “flatten” unequal signal intensities over a specified wavelength range, which may occur after an amplification stage (e.g., EDFA, Raman amplifier, etc.). GFFs may ensure that all amplified channels have the same gain, thereby maintaining signal quality and consistency across the network. The GFFs may be reflective and/or non-reflective. The WDM1 optical component 406 may be communicatively coupled to an optical connection 416. The optical connection 416 may couple the WDM1 optical component 406 to a pump, e.g., a laser pump diode and/or any other type of pump, and/or to any other type of optical component. The WDM optical component may be a splitter that may be configured to split, decouple, and/or separate optical signals. Alternatively, or in addition, the WDM optical component may be a combiner or any other suitable optical component that may be configured to combine, multiplex, couple, etc. optical signals.

Similarly, the fiber 2 403 may include an isolator (ISO4) 405, a WDM2 optical component 407, an EDF 409, an isolator (ISO5) 411, a gain flattening filter (GFF2) 413, and a tap optical component 415 that may be positioned thereon. The tap optical component 415 may be communicatively coupled to the tap optical component 414 via an optical loopback connection 418, thereby creating a loopback between fiber 402 and fiber 403. The isolator 405 may be configured to be communicatively coupled to the WDM2 optical component 407, which, in turn, may be communicatively coupled to the isolator 411 using EDF 409. The isolator 411 may be communicatively coupled to the GFF2 413, which, in turn, may be communicatively coupled to the tap optical component 415 for further communicative coupling to other optical components. The WDM2 optical component 407 may be communicatively coupled to an optical connection 417. The optical connection 417 may couple the WDM2 optical component 407 to a pump, e.g., a laser pump diode and/or any other type of pump, and/or to any other type of optical component.

An optical signal transmitted on fiber 402 may be received by the isolator 404, which, as stated above, may be configured to allow optical signals to travel in one direction (e.g., west to cast for fiber 402) and not allow the signals to be passed back (e.g., cast to west for fiber 402). Then, the optical signal may be passed through the WDM1 406, which may split, decouple, separate, combine, multiplex, couple, and/or perform any other optical function. Thereafter, EDF 408 receives the optical signal and passes it to the isolator 410, which may then be input to the GFF1 412. GFF1 412 may then process the optical signal by performing gain flattening and/or gain equalization functions on the optical signal. The gain flattened optical signal may then be passed through the tap optical component 414. The tap optical component 414 may either pass the optical signal to an output optical device (not shown in FIG. 4) that may be communicatively coupled to the fiber 402's east end and/or loopback the signal, via the optical loopback connection 418 to the tap 415 that may transmit it to an output optical device (not shown in FIG. 4) that may be communicatively coupled to the fiber 403's west end.

Transmission of optical signals on fiber 403 may be similar to the transmission of optical signals on fiber 402. In particular, the isolator 405 receives optical signal transmitted from an input device (not shown in FIG. 4) communicatively coupled at the east end of the fiber 403. The optical signal may then be passed through the WDM2 407, which, similar to the WDM1 406, may split, decouple, separate, combine, multiplex, couple, and/or perform any other optical function on the optical signal. The EDF 409 may then receive and/or amplify the optical signal and pass it to the isolator 411 and may then be transmitted to the GFF2 413 that may perform gain flattening and/or gain equalization functions on the optical signal. The gain flattened optical signal may then be transmitted through the tap optical component 415, which may either transmit the optical signal to fiber 403's output optical device (not shown in FIG. 4) and/or loopback the signal, via the optical loopback connection 418 to the tap 414.

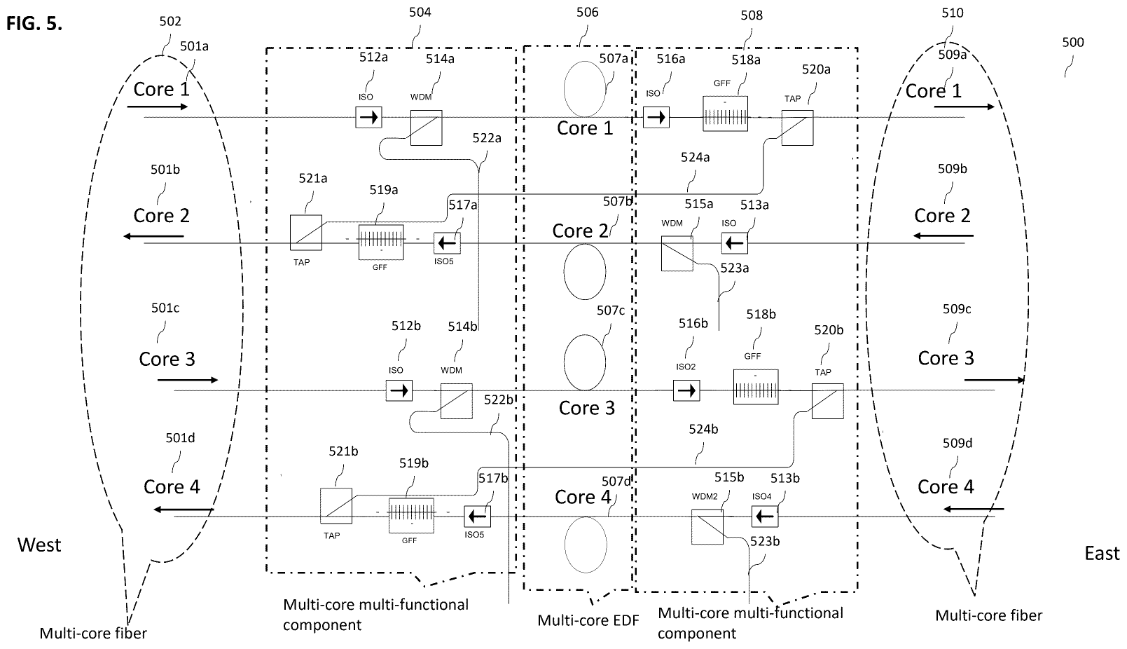

FIG. 5 illustrates an example optical communication system 500 that may include a 4-core bi-directional amplifier with multi-core EDF, and multi-core multifunctional components, according to some implementations of the current subject matter. The system may implement use of multi-core EDF with opposite direction of transmission and core pumping for odd and even numbered cores, and two symmetric components that have amplifier input functions for one core pair and amplifier output functions for other core pair. In particular, the optical communication system 500 may include a multi-core fiber optical component 502, a multi-core multi-functional optical component 504, a multi-core EDF optical component 506, a multi-core multi-functional optical component 508, and a multi-core fiber optical component 510. The multi-core components 502-510 may be 2-core, 4-core components, and/or any other multi-core components. Alternatively, or in addition, the components 502-510 may be single core components. One or more or all or each of the components 502-510 may be modular and/or interchangeable using like or different optical components. For example, component 504, as a module (with all its sub-components) may be removed and replaced with another like component 504 or a different optical component, as a module, where the newly “inserted” component 504 may be communicatively coupled to other components 502-510 upon positioning with all optical connections between modules appropriate and accurately aligned with one another. Further, one or more components may be interchangeable with one another, e.g., component 504, as a module, may be interchanged with component 508, as a module. Moreover, the system 500 may be configured to function without one or more components. For instance, the system 500 may function with only component 504, where the component 504 may be coupled to separate core fibers. Alternatively, or in addition, sub-components of each component 502-510 may be separate from other sub-components and/or formed into separate modules, as discussed herein. As can be understood, any configuration of components 502-510 may be possible.

Referring back to FIG. 5, for case of illustration only and without limitation, the components 502-510 may be assumed to be 4-core components. As shown in FIG. 5, the component 502 may include one or more cores 501 (a, b, c, d). The cores 501 may be configured to transmit signals in different directions. For example, core 1 501a and core 3 501c may transmit optical signals from west to east, and core 2 501b and core 4 501d may transmit optical signals from east to west. As can be understood, the “east” and “west” designations are arbitrary and are provided herein for illustrative purposes only.

The component 510 may be similar to the component 502. In particular, component 510 may include one or more cores 509 (a, b, c, d). The cores 509 may be configured to transmit signals in different directions. For example, core 1 509a and core 3 509c may transmit optical signals from west to cast, and core 2 509b and core 4 509d may transmit optical signals from cast to west. The core 509a may be configured to receive optical signals that originated at the core 501a (and/or looped back from core 501b). The core 509b may be configured to transmit optical signals toward core 501b. Similarly, core 509c may be configured to receive optical signals that originated at the core 501c (and/or looped back from core 501d). The core 509d may be configured to transmit optical signals toward core 501d.

In some implementations, the component 504 may include two cores having amplifier input functions that may include an isolator and a WDM pump combiner, and two cores amplifier output functions that may include an isolator, a gain flattening filter (GFF) and a tap for line monitoring. For example, the component 504 may be an amplifier input (e.g., isolator and WDM) for cores 1 and 3, and an amplifier output (e.g., isolator, GFF, tap) for cores 2 and 4. The same component may be applied symmetrically in the opposite direction, as shown in FIG. 5.

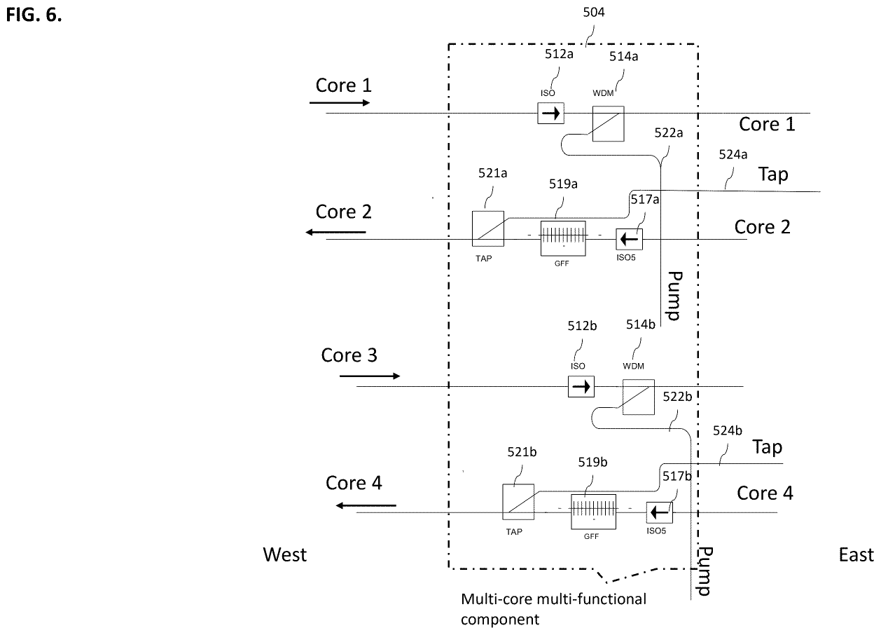

The component 504 (as shown in more detail in FIG. 6) may include an isolator 512a and a WDM optical component 514a that, upon positioning of the component 504 for connection with one or more other components 502-510, may be communicatively coupled to an optical communication path formed by the core 1 501a and core 1 509a. The isolator 512a may be configured to be communicatively coupled to the WDM optical component 514a. An optical signal transmitted on core 1 501a may be passed through the isolator 512a and then transmitted through the WDM optical component 514a, which may then further pass it on the optical connection to one or more other optical components of one or more of components 502-510. The WDM optical component 514a may be communicatively coupled to an optical connection 522a that may couple the WDM optical component 514a to a pump, e.g., a laser pump diode and/or any other type of pump, and/or to any other type of optical component (not shown in FIG. 5). Similar to FIG. 4, the WDM optical component 514a (and/or any other WDM optical component of the system 500) may be a splitter, a combiner or any other optical component.

The component 504 may also include an isolator 517a, a GFF 519a, and a tap optical component 521a, all of which, upon positioning of the component 504 for connection with one or more other components 502-510, may be communicatively coupled to an optical communication path formed by the core 2 501b and core 2 509b. Optical signals may be received by the isolator 517a, then passed on to the GFF 519a for gain equalization and/or flattening, where the flattened optical signals may be processed by the tap optical component 521a, and then either passed to the core component 502 (via core 2 501b) and/or looped back via optical connection 524a to a tap optical component 522a of the component 508. The components 512a, 514a, 517a, 519a, and 521a may form a set of optical components that may be arranged in a repeating fashion within component 504 for coupling to appropriate optical connections.

For example, the component 504 may include an isolator 512b and a WDM optical component 514b that, upon positioning of the component 504 for connection with one or more other components 502-510, may be communicatively coupled to the optical communication path formed by the core 3 501c and core 3 509c. The isolator 512b, which may be similar to the isolator 512a, may be configured to be communicatively coupled to the WDM optical component 514b, which may be similar to the WDM optical component 514a. An optical signal transmitted on core 3 501c may be passed through the isolator 512b and then transmitted through the WDM optical component 514b, which may then further pass it on the optical connection to one or more other optical components of one or more of components 502-510. The WDM optical component 514b may be communicatively coupled to an optical connection 522b that may couple the WDM optical component 514b to a pump and/or to any other type of optical component (not shown in FIG. 5).

The component 504 may likewise include an isolator 517b, a GFF 519b, and a tap optical component 521b, all of which, upon positioning of the component 504 for connection with one or more other components 502-510, may be communicatively coupled to an optical communication path formed by the core 4 501d and core 4 509d. Optical signals received by the isolator 517b may be passed to the GFF 519b and the flattened optical signals may then be transmitted to the tap optical component 521b, which may pass them to the core component 502 (via core 4 501d) and/or loop them back via optical connection 524b to a tap optical component 522b of the component 508.

The core EDF component 506 may include one or more EDF core components 507 (a, b, c, d). The component 506 may be configured to provide coupling between components 504 and 508. It may also provide amplification functionalities through one or more of its EDF components 507. Each respective EDF component 507 may be coupled to a respective component within components 504 and 508. For example, EDF component 507a may be communicatively coupled to core 1 501a of the component 502, the isolator 512a and the WDM optical component 514a of the component 504, the isolator 516a, the GFF 518a, and tap optical component 520a of the component 508, as well as core 1 509a of the component 510, thereby forming a communication path that may transmit optical signals from the west end of the system to its cast end on core 1. Similarly, EDF component 507b may be communicatively coupled to core 2 509b of the component 510, the isolator 513a and the WDM optical component 515a of the component 508, the isolator 517a, the GFF 519a, and the tap optical component 521a of the component 502, as well as core 2 501b of the component 502, thereby forming a communication path that may transmit optical signals from the east end to the west end on core 3. Likewise, EDF component 507c may be communicatively coupled to core 3 501c of the component 502, the isolator 512b and the WDM optical component 514b of the component 504, the isolator 516b, the GFF 518b, and tap optical component 520b of the component 508, as well as core 3 509c of the component 510, thereby forming a communication path that may transmit optical signals from the west end to the cast end on core 3. Also, EDF component 507d may be communicatively coupled to core 4 509d of the component 510, the isolator 513b and the WDM optical component 515b of the component 508, the isolator 517b, the GFF 519b, and the tap optical component 521b of the component 502, as well as core 4 501d of the component 502, thereby forming a communication path that may transmit optical signals from the east end to the west end on core 4.

The component 508 may be similar to the component 504, in that it may include sub-components that may be similar to the sub-components of the component 504 and that may be positioned on alternate cores. In particular, the component 508 may include the isolator 516a, a GFF 518a, and a tap optical component 520a, all of which, upon positioning of the component 508 for connection with one or more other components 502-510, may be communicatively coupled to the optical communication path formed by the cores 1 501a and 509a. Optical signals may be received by the isolator 516a (e.g. from EDF core component 507a), then passed on to the GFF 518a for gain equalization and/or flattening, and the flattened optical signals may be processed by the tap optical component 520a, and then either passed to the core component 510 (via core 2 509b) and/or looped back via the optical connection 524a to the tap optical component 521a of the component 502.

The component 508 may also include an isolator 513a and a WDM optical component 515a that, upon positioning of the component 508 for connection with one or more other components 502-510, may be communicatively coupled to the optical communication path formed by the cores 2 501b and 509b. The isolator 513a may be configured to be communicatively coupled to the WDM optical component 515a. An optical signal transmitted on core 2 509b may be passed through the isolator 513a and then transmitted through the WDM optical component 515a, which may then pass it on the optical connection to one or more other optical components of one or more of components 502-510, for example, EDF core 507b. The WDM optical component 515a may be communicatively coupled to an optical connection 523a that may couple the WDM optical component 515a to a pump and/or any other type of optical component (not shown in FIG. 5). Similar to the component 504, the sub-components 513a, 515a, 516a, 518a, and 520a may form a set of optical components that may be arranged in a repeating fashion within component 508 for coupling to appropriate optical connections.

Similar to the arrangement of the sub-components 513a, 515a, 516a, 518a, and 520a, the component 508 may include an isolator 516b, a GFF 518b, and a tap optical component 520b, all of which, upon positioning of the component 508 for connection with one or more other components 502-510, may be communicatively coupled to the optical communication path formed by the cores 3 501c and 509c. Optical signals received by the isolator 516b (e.g., from the EDF core 507c) may be passed to the GFF 518b and the flattened optical signals may then be transmitted to the tap optical component 520b, which may pass them to the core component 510 (via core 3 509c) and/or loop them back via optical connection 524b to the tap optical component 521b of the component 502.

Likewise, the component 508 may include an isolator 513b and a WDM optical component 515b that, upon positioning of the component 508 for connection with one or more other components 502-510, may be communicatively coupled to the optical communication path formed by the cores 4 501d and 509d. The isolator 513b, which may be similar to the isolator 513a, may be configured to be communicatively coupled to the WDM optical component 515b, which may be similar to the WDM optical component 515a. An optical signal transmitted on core 4 509d may be passed through the isolator 513b and then transmitted through the WDM optical component 515b, which may then pass it on the optical connection to one or more other optical components of one or more of components 502-510 (e.g., EDF core 507d). The WDM optical component 515b may be communicatively coupled to an optical connection 523b that may couple the WDM optical component 515b to a pump and/or to any other type of optical component (not shown in FIG. 5).

The optical signals transmitted on respective cores 501 and 509 may be configured to pass through the sub-components of the modular components 504-508. For example, an optical signal transmitted on core 501a may be transmitted through the isolator 512a, WDM optical component 514a, EDF core 507a, isolator 516a, GFF 518a, and tap optical component 520a, the latter of which may pass it on to the core 1 509a and/or loop it back to the tap optical component 521a. An optical signal transmitted on core 501b may be transmitted through the isolator 513a, WDM optical component 515a, EDF core 507b, isolator 517a, GFF 519a, and tap optical component 521a (which may pass it on to the core 1 501b and/or loop it back to the tap optical component 520a). The optical signals may be transmitted in a similar fashion using sub-components positioned on communication paths formed by the cores 3 501c and 509c as well as cores 4 509d and 501d.

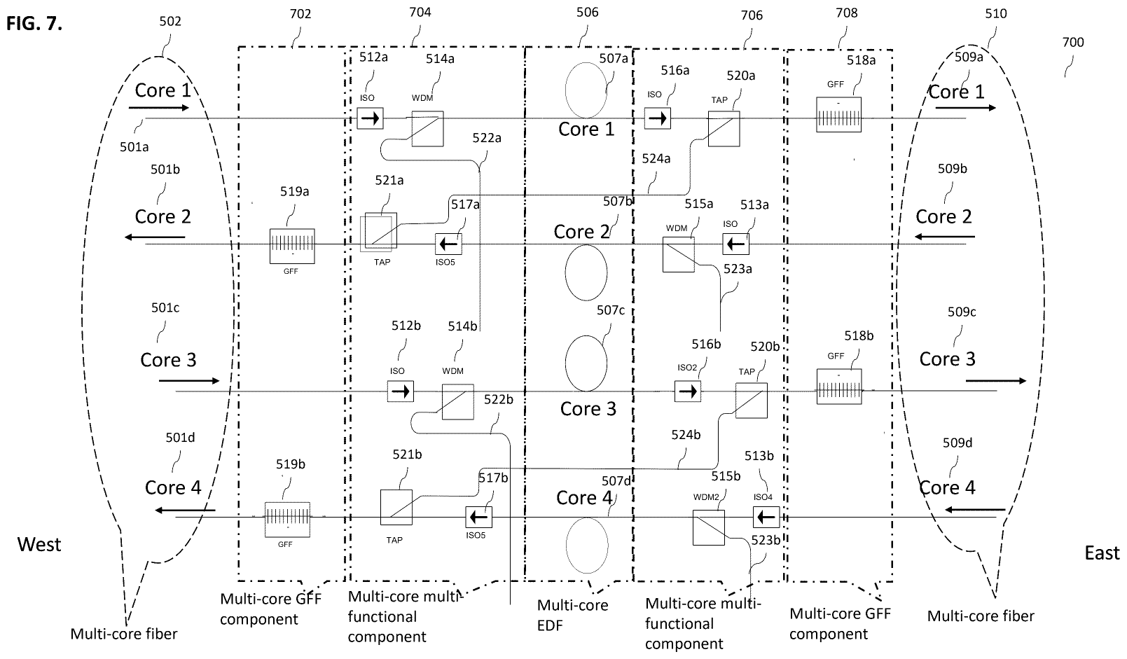

FIG. 7 illustrates another example optical communication system 700 that may be 4-core bi-directional amplifier optical signal communications system that may include 4-core EDF and 4-core multifunctional components, according to some implementations of the current subject matter. The components of the system 700 shown in FIG. 7 may be similar to the components shown in FIG. 5.

In particular, the components of the system 700 may include an amplifier input (e.g., isolator and WDM) for cores 1 and 3, and an amplifier output (e.g., isolator, tap) for cores 2 and 4, a component with GFFs core 1 and 3 at amplifier output and bypaths for cores 2 and 4 at amplifier input. The same components may be applied symmetrically in the opposite direction, as shown in FIG. 6. Moreover, as is also shown in FIG. 7, the system 700 may include a 4-core amplifier architecture without use of FIFO devices. In some example, non-limiting implementations, the system 700 may use of 4-core EDF with opposite direction of transmission and core pumping for odd and even numbered cores, and two sets of symmetric components that have amplifier input functions for one core pair and amplifier output functions for other core pair. GFF function(s) may be separated and may allow GFF component to be based on 4-core fiber where fiber gratings are written on two cores out of 4.

As shown in FIG. 7, the system 700 may differ from the system 500 shown in FIG. 5 by having the GFF sub-components be part of a separate optical component (e.g., module). The system 700 may include the multi-core fiber optical component 502 (as is also shown in FIG. 5), a multi-core GFF component 702, a multi-core multi-functional optical component 704, the multi-core EDF optical component 506 (as is also shown in FIG. 5), a multi-core multi-functional optical component 706, a multi-core GFF component 708, and the multi core fiber optical component 510 (as is also shown in FIG. 5). In the system 700, the component 504 shown in FIG. 5 may be split into separate components 702 and 704. Similarly, the component 508 shown in FIG. 5 may be split into separate component 706 and 708. In some implementations, while components 702, 704, 506, 706, and/or 708 are shown as separate modules, they may be combined into single modules, as desired.

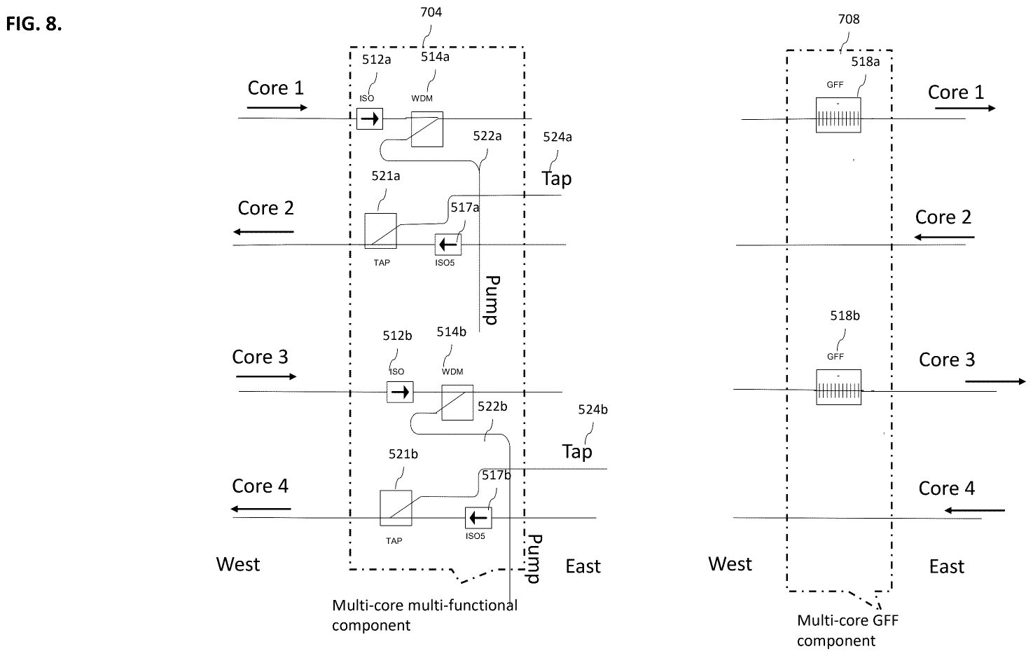

The GFF component 702 (as shown in more detail in FIG. 8) may include GFF components 519a and 519b and may be communicatively coupled to the component 502 and component 704. Similarly, the GFF component 708 may include GFF components 518a and 518b and may be communicatively coupled to the component 706 and the component 510.

The component 704 (as shown in more detail in FIG. 8) may include the isolator 512a and the WDM optical component 514a that, upon positioning of the component 704 for connection with one or more other components of the system 700, may be communicatively coupled to an optical communication path formed by the core 1 501a and core 1 509a. The connections formed by the sub-components of the component 704 may be similar to the connections formed by the component 504 shown in FIG. 5. The component 704 may also include the isolator 517a and the tap optical component 521a. The tap optical component 521a may be communicatively coupled to the GFF component 519a of the GFF component 702.

Similarly, the component 704 may include the isolator 512b and the WDM optical component 514b that, upon positioning of the component 704. The component 704 may likewise include the isolator 517b and the tap optical component 521b. The isolator 517b may be communicatively coupled to the GFF component 519b of the GFF component 702.

The component 706 may be similar to the component 704 and may include sub-components that may be similar to the sub-components of the component 704. For example, the component 706 may include the isolator 516a and the tap optical component 520a, which may be communicatively coupled to the GFF component 518a of the GFF component 708. Further, the component 706 may include the isolator 513a and the WDM optical component 515a. The isolator 513a may be configured to be communicatively coupled to the WDM optical component 515a. The component 706 may include the isolator 516b and the tap optical component 520b, which may be communicatively coupled to the GFF component 518b of the GFF component 708. Likewise, the component 706 may include the isolator 513b and the WDM optical component 515b.

Once components 702, 704, 506, 706, and 708 are positioned between core components 502 and 510, optical communication paths may be formed by one or more their respective sub-components. For example, a communication path formed between core 1 502a and core 1 509a may include sub-components of component 704 (e.g., the isolator 512a and the WDM optical component 514a), which may be communicatively coupled to the EDF core component 507a, which, in turn, may be communicatively coupled to sub-components of component 706 (e.g., the isolator 516a and the tap component 520a), and which, in turn, may be communicatively coupled to the GFF component 518a of the GFF component 708. Similarly, a communication path formed between core 2 509b and core 2 501b may include sub-components of component 706 (e.g., the isolator 513a and the WDM optical component 515a), which may be communicatively coupled to the EDF core component 507a, which, in turn, may be communicatively coupled to sub-components of component 704 (e.g., the isolator 517a and the tap component 521a), and which, in turn, may be communicatively coupled to the GFF component 519a of the GFF component 704. The tap optical components 521a of the component 704 and 520a of the component 706 may be communicatively coupled using connection 524a to form a loopback. Moreover, the WDM components 514a of the component 704 and 515a of the component 706 may be coupled to pumps and/or any other optical components using their respective connections (e.g., for monitoring, etc.). Similar connections may be made for cores 3 and 4, respectively.

The optical signals transmitted on respective cores 501 and 509 may be configured to pass through the sub-components of the modular components 702, 704, 506, 706, and 708. For example, an optical signal transmitted on core 501a may be transmitted through the isolator 512a, WDM optical component 514a, EDF core 507a, isolator 516a, tap optical component 520a, and GFF component 518a. The tap optical component 520a may pass the signal on to the core 1 509a and/or loop it back to the tap optical component 521a. An optical signal transmitted on core 501b may be transmitted through the isolator 513a, WDM optical component 515a, EDF core 507b, isolator 517a, tap optical component 521a, and the GFF component 519a (the tap optical component may pass it on to the core 1 501b and/or loop it back to the tap optical component 520a). The optical signals may be transmitted in a similar fashion using sub-components positioned on communication paths formed by the cores 3 501c and 509c as well as cores 4 509d and 501d.

In some implementations, the current subject matter may involve use of multicore components that both have amplifier input and output functions in pairwise fashion for odd and even cores, where grouping of component functions and amplifier structures is shown FIGS. 5-8, and fiber-based GFF, as shown in FIGS. 6-8, where grating is positioned on 2 cores out of 4. The current subject matter may have numerous benefits in that combing components into multifunctional hybrid 4-core components together with 4-core EDF may allow for space savings in the repeater bodies, and may further allow scaling up capacities. Using of 4-core multifunctional components may also simplify manufacturing assembly. Additionally, pairwise core functionality may further be extended to larger number of cores.

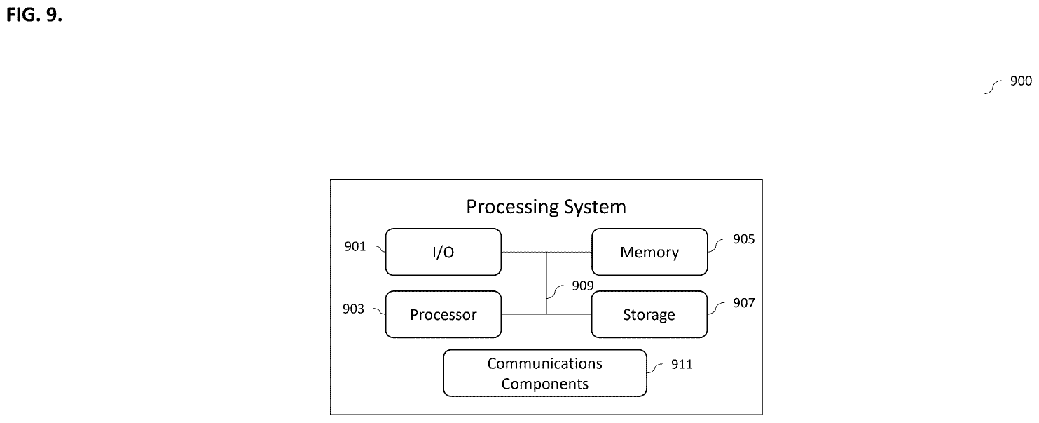

FIG. 9 illustrates an exemplary system 900 for processing and/or controlling one or more operations of the systems shown in FIGS. 5-8. As shown in FIG. 9, the processing system 900 may include an input/output (I/O) device 901, a processor 903, a memory 905, a storage 907, and one or more communication components 911. Each of the components 901-507 may be interconnected using a system bus 909. The processor 903 may be configured to process instructions for execution within system 900. In some implementations, the processor 903 may be a single-threaded processor. Alternatively, or in addition, the processor 903 may be a multi-threaded processor. The processor 903 may be further configured to process instructions stored in the memory 905 and/or in the storage 907, including, but not limited to, receiving and/or sending information through the I/O device 901. The memory 905 may store information within the system 900. In some implementations, the memory 905 may be a computer-readable medium. Alternatively, or in addition, the memory 905 may be a volatile memory unit. In yet some implementations, the memory 905 may be a non-volatile memory unit. The storage 907 may be capable of providing mass storage for the system 900. In some implementations, the storage 907 may be a computer-readable medium. Alternatively, or in addition, the storage 907 may be a floppy disk device, a hard disk device, an optical disk device, a tape device, non-volatile solid state memory, or any other type of storage device. The I/O device 901 may provide input/output operations for the system 900. In some implementations, the I/O device 901 may include a keyboard and/or pointing device. Alternatively, or in addition, the I/O device 901 may include a display unit for displaying graphical user interfaces.

In some example implementations, one or more components of the system 900 may include any combination of hardware and/or software. In some implementations, one or more components of the system 900 may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example implementations, one or more components of the system 900 may be disposed on a single computing device and/or may be part of a single communications network. Alternatively, or in addition to, such services may be separately located from one another.

In some implementations, the system 900's one or more components may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system 900 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 900 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. One or more components of the system 900 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some example implementations, one or more components of the system 900 may execute one or more applications, such as software applications, that enable, for example, network communications with one or more components of system 900 and transmit and/or receive data.

One or more components of the system 900 may include and/or be in communication with one or more servers via one or more networks and may operate as a respective front-end to back-end pair with one or more servers. One or more components of the system 900 may transmit, for example, from a mobile device application (e.g., executing on one or more user devices, components, etc.), one or more requests to one or more servers. The requests may be associated with retrieving data from servers. The servers may receive the requests from the components of the system 900. Based on the requests, servers may be configured to retrieve the requested data from one or more databases. Based on receipt of the requested data from the databases, the servers may be configured to transmit the received data to one or more components of the system 900, where the received data may be responsive to one or more requests.

The system 900 may include and/or be communicatively coupled to one or more networks. In some implementations, networks may be one or more of a wireless network, a wired network or any combination of wireless network and wired network and may be configured to connect the components of the system 900 and/or the components of the system 900 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, and home networks.

The system 900 may include and/or be communicatively coupled to one or more servers, which may include one or more processors that maybe coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system 900.

The various elements of the components as previously described with reference to FIGS. 2-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium and supplied to various customers or manufacturing facilities to load into the fabrication machines that make the logic or processor. Some implementations may be implemented, for example, using a machine-readable medium or article which may store an instruction or a set of instructions that, if executed by a machine, may cause the machine to perform a method and/or operations in accordance with the implementations. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writable or rewritable media, digital or analog media, hard disk, floppy disk, Compact Disk Read Only Memory (CD-ROM), Compact Disk Recordable (CD-R), Compact Disk Rewritable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in implementations.

At least one computer-readable storage medium may include instructions that, when executed, cause a system to perform any of the computer-implemented methods described herein.

Some implementations may be described using the expression “one implementation” or “an implementation” along with their derivatives. These terms mean that a particular feature, structure, or characteristic described in connection with the implementation is included in at least one implementation. The appearances of the phrase “in one implementation” in various places in the specification are not necessarily all referring to the same implementation. Moreover, unless otherwise noted the features described above are recognized to be usable together in any combination. Thus, any features discussed separately may be employed in combination with each other unless it is noted that the features are incompatible with each other.

In one aspect, an apparatus for transmission of optical signals may include one or more first multi-core optical components coupled to all fiber cores in a multi-core fiber; an erbium-doped fiber amplifier (EDFA) optical component coupled to all fiber cores in the multi-core fiber, wherein the EDFA optical component includes a plurality of EDFAs and each fiber core in the multi-core fiber is coupled to an EDFA in the plurality of EDFAs; one or more second multi-core optical components coupled to all fiber cores in the multi-core fiber, wherein the EDFA optical component is coupled to all fiber cores in the multi-core fiber between the one or more first multi-core optical components and the one or more second multi-core optical components; the one or more first multi-core components are coupled at an input to a first portion of fiber cores in all fiber cores and provide one or more first functions, and are coupled at an output from a second portion of fiber cores in all fiber cores and provide one or more second functions; the one or more second multi-core components are coupled at an output from the first portion of fiber cores in all fiber cores and provide one or more second functions, and are coupled to an input to the second portion of fiber cores in all fiber cores and provide the one or more first functions.

The apparatus may include wherein the first portion of fiber cores transmits optical signals in an opposite direction to a direction of transmission of optical signals by the second portion of fiber cores.

The apparatus may include wherein the one or more first functions are provided by at least one of: a first isolator, a wavelength division multiplexing (WDM) optical component, and any combination thereof.

The apparatus may include wherein the WDM optical component is coupled to a pump.

The apparatus may include wherein the one or more second functions are provided by at least one of: a tap optical component, a gain flattening filter (GFF), a second isolator, and any combination thereof.

The apparatus may include wherein tap optical components of adjacent fiber cores in all fiber cores are communicatively coupled.

The apparatus may include wherein the tap optical component, the gain flattening filter (GFF), and the second isolator are disposed within a single multi-core component in at least one of: the one or more first multi-core components and the one or more second multi-core components.

The apparatus may include wherein the tap optical component and the second isolator are disposed within a single multi-core component in at least one of: the one or more first multi-core components and the one or more second multi-core components; and the gain flattening filter (GFF) is disposed within another single multi-core component in at least one of: the one or more first multi-core components and the one or more second multi-core components.

The apparatus may include wherein the tap optical components are configured to provide monitoring of one or more fiber cores in all cores.

The apparatus may include wherein the multi-core fiber includes at least one of: two fiber cores, four fiber cores, and any combination thereof.

In one aspect, a method for transmission of optical signals may include providing an apparatus for transmission of optical signals having one or more first multi-core optical components coupled to all fiber cores in a multi-core fiber; an erbium-doped fiber amplifier (EDFA) optical component coupled to all fiber cores in the multi-core fiber, wherein the EDFA optical component includes a plurality of EDFAs and each fiber core in the multi-core fiber is coupled to an EDFA in the plurality of EDFAs; one or more second multi-core optical components coupled to all fiber cores in the multi-core fiber, wherein the EDFA optical component is coupled to all fiber cores in the multi-core fiber between the one or more first multi-core optical components and the one or more second multi-core optical components; the one or more first multi-core components are coupled at an input to a first portion of fiber cores in all fiber cores and provide one or more first functions, and are coupled at an output from a second portion of fiber cores in all fiber cores and provide one or more second functions; the one or more second multi-core components are coupled at an output from the first portion of fiber cores in all fiber cores and provide one or more second functions, and are coupled to an input to the second portion of fiber cores in all fiber cores and provide the one or more first functions; and transmitting, using the apparatus, one or more optical signals on or more fiber cores.

The method may include wherein the first portion of fiber cores transmits optical signals in an opposite direction to a direction of transmission of optical signals by the second portion of fiber cores.

The method may include wherein the one or more first functions are provided by at least one of: a first isolator, a wavelength division multiplexing (WDM) optical component, and any combination thereof.

The method may include wherein the WDM optical component is coupled to a pump.

The method may include wherein the one or more second functions are provided by at least one of: a tap optical component, a gain flattening filter (GFF), a second isolator, and any combination thereof.

The method may include wherein tap optical components of adjacent fiber cores in all fiber cores are communicatively coupled.

The method may include wherein the tap optical component, the gain flattening filter (GFF), and the second isolator are disposed within a single multi-core component in at least one of: the one or more first multi-core components and the one or more second multi-core components.

The method may include wherein the tap optical component and the second isolator are disposed within a single multi-core component in at least one of: the one or more first multi-core components and the one or more second multi-core components; and the gain flattening filter (GFF) is disposed within another single multi-core component in at least one of: the one or more first multi-core components and the one or more second multi-core components.

The method may include wherein the tap optical components are configured to provide monitoring of one or more fiber cores in all cores.

The method may include wherein the multi-core fiber includes at least one of: two fiber cores, four fiber cores, and any combination thereof.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single implementation for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separate implementation. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example implementations has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. An apparatus for transmission of optical signals, comprising:
one or more first multi-core optical components coupled to all fiber cores in a multi-core fiber;
an erbium-doped fiber amplifier (EDFA) optical component coupled to all fiber cores in the multi-core fiber, wherein the EDFA optical component includes a plurality of EDFAs and each fiber core in the multi-core fiber is coupled to an EDFA in the plurality of EDFAs;
one or more second multi-core optical components coupled to all fiber cores in the multi-core fiber, wherein the EDFA optical component is coupled to all fiber cores in the multi-core fiber between the one or more first multi-core optical components and the one or more second multi-core optical components;
the one or more first multi-core components are coupled at an input to a first portion of fiber cores in all fiber cores and provide one or more first functions, and are coupled at an output from a second portion of fiber cores in all fiber cores and provide one or more second functions;
the one or more second multi-core components are coupled at an output from the first portion of fiber cores in all fiber cores and provide one or more second functions, and are coupled to an input to the second portion of fiber cores in all fiber cores and provide the one or more first functions.

2. The apparatus of claim 1, wherein the first portion of fiber cores transmits optical signals in an opposite direction to a direction of transmission of optical signals by the second portion of fiber cores.

3. The apparatus of claim 2, wherein the one or more first functions are provided by at least one of: a first isolator, a wavelength division multiplexing (WDM) optical component, and any combination thereof.

4. The apparatus of claim 3, wherein the WDM optical component is coupled to a pump.

5. The apparatus of claim 3, wherein the one or more second functions are provided by at least one of: a tap optical component, a gain flattening filter (GFF), a second isolator, and any combination thereof.

6. The apparatus of claim 5, wherein tap optical components of adjacent fiber cores in all fiber cores are communicatively coupled.

7. The apparatus of claim 5, wherein the tap optical component, the gain flattening filter (GFF), and the second isolator are disposed within a single multi-core component in at least one of: the one or more first multi-core components and the one or more second multi-core components.

8. The apparatus of claim 5, wherein the tap optical component and the second isolator are disposed within a single multi-core component in at least one of: the one or more first multi-core components and the one or more second multi-core components; and
the gain flattening filter (GFF) is disposed within another single multi-core component in at least one of: the one or more first multi-core components and the one or more second multi-core components.

9. The apparatus of claim 5, wherein the tap optical components are configured to provide monitoring of one or more fiber cores in all cores.

10. The apparatus of claim 1, wherein the multi-core fiber includes at least one of: two fiber cores, four fiber cores, and any combination thereof.

11. A method for transmission of optical signals, comprising:
providing an apparatus for transmission of optical signals having one or more first multi-core optical components coupled to all fiber cores in a multi-core fiber;
an erbium-doped fiber amplifier (EDFA) optical component coupled to all fiber cores in the multi-core fiber, wherein the EDFA optical component includes a plurality of EDFAs and each fiber core in the multi-core fiber is coupled to an EDFA in the plurality of EDFAs;
one or more second multi-core optical components coupled to all fiber cores in the multi-core fiber, wherein the EDFA optical component is coupled to all fiber cores in the multi-core fiber between the one or more first multi-core optical components and the one or more second multi-core optical components;
the one or more first multi-core components are coupled at an input to a first portion of fiber cores in all fiber cores and provide one or more first functions, and are coupled at an output from a second portion of fiber cores in all fiber cores and provide one or more second functions;
the one or more second multi-core components are coupled at an output from the first portion of fiber cores in all fiber cores and provide one or more second functions, and are coupled to an input to the second portion of fiber cores in all fiber cores and provide the one or more first functions; and
transmitting, using the apparatus, one or more optical signals on or more fiber cores.

12. The method of claim 11, wherein the first portion of fiber cores transmits optical signals in an opposite direction to a direction of transmission of optical signals by the second portion of fiber cores.

13. The method of claim 12, wherein the one or more first functions are provided by at least one of: a first isolator, a wavelength division multiplexing (WDM) optical component, and any combination thereof.

14. The method of claim 13, wherein the WDM optical component is coupled to a pump.

15. The method of claim 13, wherein the one or more second functions are provided by at least one of: a tap optical component, a gain flattening filter (GFF), a second isolator, and any combination thereof.

16. The method of claim 15, wherein tap optical components of adjacent fiber cores in all fiber cores are communicatively coupled.

17. The method of claim 15, wherein the tap optical component, the gain flattening filter (GFF), and the second isolator are disposed within a single multi-core component in at least one of: the one or more first multi-core components and the one or more second multi-core components.

18. The method of claim 15, wherein the tap optical component and the second isolator are disposed within a single multi-core component in at least one of: the one or more first multi-core components and the one or more second multi-core components; and
the gain flattening filter (GFF) is disposed within another single multi-core component in at least one of: the one or more first multi-core components and the one or more second multi-core components.

19. The method of claim 15, wherein the tap optical components are configured to provide monitoring of one or more fiber cores in all cores.

20. The method of claim 11, wherein the multi-core fiber includes at least one of: two fiber cores, four fiber cores, and any combination thereof.
